(19) United States
(12) Patent Application Publication
(10) Pub. No.: US 2020/0209902 A1
(43) Pub. Date: Jul. 2, 2020

(54) LOW COST AUTOMOTIVE LOW DROPOUT REGULATOR (LDO) WITH INTEGRATED SWITCHED CAPACITOR BOOST REGULATION

(71) Applicant: Continental Automotive Systems Inc., Auburn HIlls, MI (US)

(72) Inventor: Sergio A. Elias-Palacios, Rochester Hills, MI (US)

(21) Appl. No.: 16/385,274

(22) Filed: Apr. 16, 2019

Related U.S. Application Data
(60) Provisional application No. 62/785,770, filed on Dec. 28, 2018.

(51) Int. Cl. G05F 1/56; H02H 5/04; H02H 1/00

(52) U.S. Cl. CPC G05F 1/56; H02H 1/0007; H02H 5/04

(57) ABSTRACT

A power regulator includes a power input, a linear regulator connected to the power input and a switched capacitor boost regulator connected to the power input. The linear regulator and the switched capacitor boost regulator are configured to operate mutually exclusively. A pass switched element is configured to prevent the switched capacitor boost regulator from back feeding itself and to allow the mutually exclusive operation with the linear regulator. A control logic is configured to control operation of the linear regulator and the switched capacitor boost regulator.

### CROSS-REFERENCE TO RELATED APPLICATION

This application claims priority to U.S. Provisional Application No. 62/785,770 filed on Dec. 28, 2018.

### TECHNICAL FIELD

The present disclosure relates generally to electrical systems for utilization in automotive vehicles, and more specifically to a low dropout regulator with improved operations.

### BACKGROUND

Modern automotive vehicles incorporate many electrically controlled subsystems that enhance the operation of the vehicle. Each of these subsystems is controlled via a corresponding controller, and the controller requires a regulated power input in order to maintain continued operation.

For many of the subsystems, it is important to be able to provide minimum subsystem operations during operation of the vehicle and to properly save the context of the operations in the case of an emergency reset of the controller. In addition, it is important to robustly minimize the risk of controller memory corruption during power supply dips and drops that may be frequent during operation of the vehicle. Typically this is solved by either using a large bulk capacitance, a DC-DC converter, or by simply limiting the software to perform a bare minimum of operations during a low power event.

It is desirable to generate system that is simpler than the existing systems, but retains effectiveness. It is further desirable to reduce the number of external components by avoiding the usage of inductors within the power regulator.

### SUMMARY OF THE INVENTION

In one exemplary embodiment a power regulator includes a power input, a linear regulator connected to the power input and a switched capacitor boost regulator connected to the power input, wherein the linear regulator and the switched capacitor boost regulator are configured to operate mutually exclusive, a pass switched element configured to prevent the switched capacitor boost regulator from back feeding itself and to allow mutually exclusive operation with the linear regulator, and a control logic configured to control operation of the linear regulator and the switched capacitor boost regulator.

An exemplary method for providing regulated power to a vehicle controller includes receiving unregulated power from a power source via a power input, providing regulated power using a linear regulator while the unregulated power exceeds a minimum power characteristic threshold, providing regulated power using a switched capacitance boost regulator in response to the unregulated power falling below the minimum power characteristic threshold, and wherein operation of the linear regulator and the switched capacitance boost regulator is mutually exclusive.

In another exemplary embodiment a low drop out regulator for vehicle systems includes a DC power source, a linear regulator connected to the DC power source and a switched capacitance boost regulator connected to the DC power source, the low drop linear regulator and the switched capacitance boost regulator being in electrical parallel, a battery voltage and slew rate sensor configured to detect an output voltage and slew rate of the DC power source, a control logic module configured to control the linear regulator and the switched capacitor boost regulator such that the linear regulator and the switch capacitance boost regulator are operated in a mutually exclusive manner, a reset control module configured to output a reset signal in response to the control logic module determining a power dip at the DC power source will exceed a predefined duration, an overcurrent detection sensor configured to detect an output current of the linear regulator and provide the detected output current to the control logic module, and a thermal shutdown module configured to monitor a temperature of the control logic module and initiate a shutdown in response to temperatures exceeding a threshold.

These and other features of the present invention can be best understood from the following specification and drawings, the following of which is a brief description.

### BRIEF DESCRIPTION OF THE DRAWINGS

FIG. 1 schematically illustrates an exemplary power system for power a vehicle controller.

FIG. 2 schematically illustrates an exemplary power regulator for the vehicle controller of FIG. 1.

FIG. 3 schematically illustrates a more detailed view of an improved low dropout voltage regulator that can be utilized as the power regulator of FIG. 2.

### DETAILED DESCRIPTION

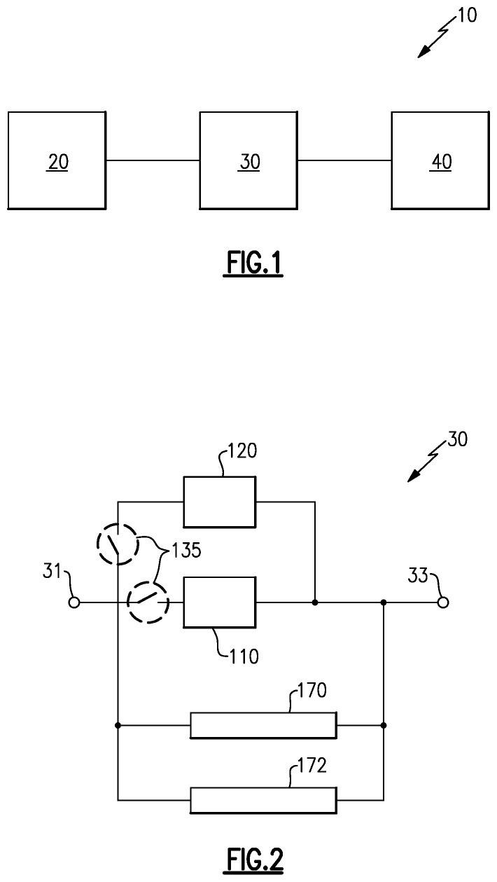

FIG. 1 schematically illustrates a controller power system 10 for providing power to a vehicle subsystem controller 40. The power system 10 includes a power source 20, such as a vehicle battery, and a power regulator 30. The power regulator 30 receives electrical power from the power source 20 and provides the power in a regulated fashion to the controller 40. By way of example, if the controller 40 requires 5 volt power for optimum operations, the regulator converts the power from the power source 20 to the requisite 5V power and provides the regulated power to the controller 40. It is appreciated that the regulator 30 can be designed or configured to provide any desirable power characteristic to the controller 40 in a regulated fashion.

During standard operations of the vehicle, it is expected that various conditions will cause transient dips and drops in the power able to be provided from the power source 20. The dips and drops typically end within a short time period (e.g. in less than 50 micro seconds), after which the power from the power supply returns to sufficient levels.

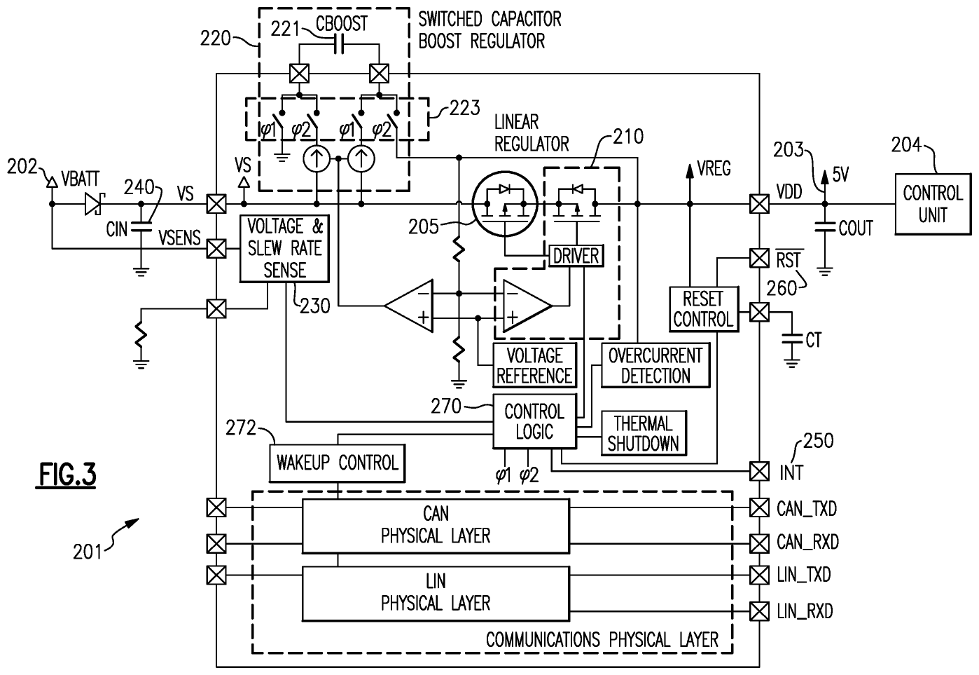

With continued reference to FIG. 1, FIG. 2 schematically illustrates a more detailed power regulator 30 for providing power from the power source 20 to the controller 40. The power regulator 30 includes an input 31 connected to the power source 20 and an output 33 connected to the controller 40. Also included within the power regulator 30 are two conventional communication layers, 170, 172, such as a CAN physical layer and an LIN physical layer.

During standard operations (i.e. when the power source 20 is providing sufficient power) a linear regulator receives power from the power source 20, provides the regulation, and passes the regulated power output to the output 33. When the power from the power source 20 begins to fall below sufficient levels, the regulator 30 switches from the linear regulator 110 to a boost regulator 120. Operation of switches 135 ensures that the boost regulator 120 and the linear regulator 110 do not operate simultaneously, and the switches 135 are controlled via internal control logic within the power regulator 30 (see FIG. 3). The boost regulator 120 is a switched capacitor boost regulator with the output voltage being controlled via controlling a charge into a capacitor.

With continued reference to FIGS. 1 and 2, FIG. 3 schematically illustrates an exemplary power regulator 201. The power regulator 201 includes a linear regulator 210 in parallel with a switched capacitor boost regulator 220. Operation of the linear regulator 210 and the switched capacitor boost regulator 220 is mutually exclusive. This mode of operation is facilitated by the pass switched element 205, providing isolation between both regulators.

By way of example, during nominal operations the power regulator 201 operates as a typical linear regulator by operating the linear regulator 210 and not the switched capacitor boost regulator 220. During this mode of operation the linear regulator 210 provides regulated power to a power rail 203. An exemplary nominal operation range can be a power source in the range of 5.5 to 16 volts, with the power rail operating at 5 V and the linear regulator 210 is operated at about 200 mA using an exposed pad package. In some examples the power rail 203 is connected to, and provides power to, a controller 204.

When the voltage from a power source 202 for the power regulator 201 falls below the nominal parameters set by a voltage reference (e.g. below 5.5 V), the switched capacitor boost regulator 220 takes over control of the power rail 203. This takeover is achieved by ceasing power output from the linear regulator 210, opening the pass switched element 205 and initiating power output from the boost regulator 220. The output voltage provided by the power rail 203 is regulated by controlling a charge into a capacitor 221 within the switched capacitor boost regulator 220 using a voltage controlled current source, and via switches 223. The switches 223 are controlled via a control logic 270. The power regulator 201 can then operate continuously during the low voltage event. By omitting inductors within the boost regulator 220, the cost of the boost regulator 220 is reduced and the boost regulator 220 is able to provide better electro-magnetic interference (EMI) compliance to the overall system.

Some controllers 204 are able to continue operating with a degraded functionality at voltages lower than 5V. By way of example, when the controller 204 is configured to assert an internal reset at 3.5V with degraded functionality, the switched capacitor boost regulator 220 is configured to deliver a lower voltage to the voltage rail 203 suitable for maintaining the operations of the controller 204 at the degraded level. By way of example, if the controller 204 is configured to operate in degraded mode at 2.5V or 1.75V, the switched capacitor boost regulator 220 can be configured to provide the regulated power for the corresponding output voltage to the voltage rail 203 during the low power mode.

In order to detect an incoming dip or drop, a battery voltage and slew rate sensor 230 is included. This sensor allows the controller 204 to anticipate power supply dips and drops and to take proper action to respond to those dips and drops without the need for excessively large hold capacitance to be built into the regulator 201. The voltage and slew rate of the power supply input 202 is sensed before a reverse battery protection and bulk capacitor 240 in order to allow steep drops in power supply voltage to be detected fast enough for the regulator 201 to predict the need to switch the power regulation from the linear regulator 210 to the switched capacitor boost regulator 220.

When the power received at the input 202 drops below requisite levels, the bulk capacitor 240 provides supplemental charge to allow the boost regulator 220 to operate. As the expected duration of any dip and drop that will be recovered from is on the order of hundreds of micro-seconds, the bulk capacitor 240 need only be charged with sufficient charge to operate the boost regulator 220 for 100 to 500 microseconds as an example. Once power from the power supply has returned to sufficient levels, and the regulator 201 has switched back over to the linear regulator 210, the bulk capacitor 240 is charged from the power supply input 202.

The output of the voltage and slew rate sensor system 230 is provided to the control logic 270. Based on the sensed voltage and slew rate, the control logic 270 outputs a main interruption (INT 250) signal and a reset (RST 260) signal to the controller 204. The main interruption (INT 250) signal informs the controller 204 that there is a likely switch to the boost regulator in the near future and allows the controller 204 to switch to a reduced operations mode. Further, the main interruption (INT 250) signal informs the controller 204 that a hard reset may occur in the near future. The reset (RST 260) signal is provided to the controller 204 when recover of the power source is not going to occur and triggers the controller 204 to reset.

By way of example, a fast falling battery voltage can trigger the interrupt 250 right away regardless of the magnitude of the voltage, thereby enabling the main control unit 204 to have sufficient time to enable a very low power mode, save the memory and/or memory state of the controller, and do any housekeeping associated with an imminent power decrease/loss.

On the other hand, battery levels that are not falling fast can be masked based on the voltage measurement, as an example, start stop operations or cold crank operations can be supported without an interruption since the minimum battery voltage is 4V during these operations, and 4V can be fully supported by the switched capacitor regulator.

The exemplary system of FIG. 3 further includes a low drop linear regulator, a switched capacitor boost regulator, a battery voltage and slew rate sensor, a bandgap reference, control logic, a reset control, overcurrent detection and a thermal shutdown module, although any number of additional conventional elements can be included within the regulator 201, depending on the needs of the controller 204, or controllers, receiving power from the power regulator 201.

In additional examples, the regulator 201 can be extended to provide further functionality such as a physical layer for CAN and LIN communications, as with other automotive regulator families. In order to facilitate such an extension, a wakeup control logic 272 is also incorporated and operated by the main control logic 270.

One exemplary usage for the regulator 201 is to allow for important applications to safely operate under certain low voltage conditions and to robustly save the memory and context of the operations under a deep battery voltage dip or drop by extending the main control unit 204 operation time without increasing the bulk storage capacitance and monitoring the fall rate in a smart and predictive mode during battery dips and drops.

It is anticipated that the regulator 201 can be used in conjunction with, or to facilitate, chassis sensors, brake system sensors, crash sensors, speed sensors, electric power steering systems, battery sensors, engine and fuel supply sensors, door handle and trunk sensors, position sensors (e.g. position of a gear, clutch master cylinder, pedal, fork positions, park PRND, etc.), TPMS sensors, immobilizer units, seat control units, door control units, and LED control units. The preceding list is merely exemplary and is not exhaustive, and the regulator 201 could be extended to any component that could benefit from the regulation described within.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A power regulator comprising:
a power input;
a linear regulator connected to the power input and a switched capacitor boost regulator connected to the power input, wherein the linear regulator and the switched capacitor boost regulator are configured to operate mutually exclusively;
a pass switched element configured to prevent the switched capacitor boost regulator from back feeding itself and to allow mutually exclusive operation with the linear regulator; and
a control logic configured to control operation of the linear regulator and the switched capacitor boost regulator.

2. The power regulator of claim 1, wherein the linear regulator and the switched capacitor boost are arranged in electrical parallel.

3. The power regulator of claim 1, further comprising a power input sensor connected to the power input, and communicatively coupled to the control logic.

4. The power regulator of claim 3, wherein the power input sensor includes at least one of a voltage sensor and a slew rate sensor.

5. The power regulator of claim 4, wherein the power input sensor includes each of a voltage sensor and a slew rate sensor.

6. The power regulator of claim 1, wherein the switched capacitor boost regulator is characterized by a lack of an inductor.

7. The power regulator of claim 1, wherein the control logic includes an interrupt output, and wherein the control logic is configured output a signal at the interrupt output prior to operating the switched capacitor boost regulator.

8. The power regulator of claim 1, further comprising a bulk capacitor connected between the power input and each of the linear regulator and the switched capacitor boost regulator.

9. The power regulator of claim 1, further comprising at least one communication layer.

10. A method for providing regulated power to a vehicle controller comprising:
receiving unregulated power from a power source via a power input;
providing regulated power using a linear regulator while the unregulated power exceeds a minimum power characteristic threshold;
providing regulated power using a switched capacitance boost regulator in response to the unregulated power falling below the minimum power characteristic threshold; and
wherein operation of the linear regulator and the switched capacitance boost regulator is mutually exclusive.

11. The method of claim 10, wherein the minimum power characteristic threshold is at least one of a slew rate threshold and a voltage threshold.

12. The method of claim 11, further comprising detecting at least one of a slew rate and a voltage rate of power received at the power input using a power characteristic sensor.

13. The method of claim 12, further comprising outputting a interrupt signal to a connected controller in response to the sensed power characteristic approaching the minimum power characteristic threshold.

14. The method of claim 12, further comprising disengaging the linear regulator and engaging the switched capacitance boost regulator in response to the sensed power characteristic falling below the minimum power characteristic threshold.

15. The method of claim 14, wherein the minimum power characteristic threshold includes a voltage threshold.

16. The method of claim 10, wherein providing regulated power using the switched capacitance boost regulator comprises drawing power from a bulk capacitor connected to the power input.

17. The method of claim 10, wherein the switched capacitance boost regulator is characterized by an absence of an inductor.

18. A low drop out regulator for vehicle systems including:
a DC power source;
a linear regulator connected to the DC power source and a switched capacitance boost regulator connected to the DC power source, the low drop linear regulator and the switched capacitance boost regulator being in electrical parallel;
a battery voltage and slew rate sensor configured to detect an output voltage and slew rate of the DC power source;
a control logic module configured to control the linear regulator and the switched capacitor boost regulator such that the linear regulator and the switch capacitance boost regulator are operated in a mutually exclusive manner;
a reset control module configured to output a reset signal in response to the control logic module determining a power dip at the DC power source will exceed a predefined duration;
an overcurrent detection sensor configured to detect an output current of the linear regulator and provide the detected output current to the control logic module; and
a thermal shutdown module configured to monitor a temperature of the control logic module and initiate a shutdown in response to temperatures exceeding a threshold.
